(19) United States
(12) Patent Application Publication
(10) Pub. No.: US 2009/0293745 A1
(43) Pub. Date: Dec. 3, 2009

(54) SHEET MONITOR FOR PERFECTOR

(75) Inventor: Yoichiro ABE, Noda-shi (JP)

Correspondence Address: BIRCH STEWART KOLASCH & BIRCH, PO BOX 747, FALLS CHURCH, VA, 22040-0747, US

(73) Assignee: KOMORI CORPORATION, Tokyo (JP)

(21) Appl. No.: 12/467,447

(22) Filed: May 18, 2009

(30) Foreign Application Priority Data
May 28, 2008 (JP) 2008-138977

(51) Int. Cl. B41F 5/02

(52) U.S. Cl. 101/229

(57) ABSTRACT

A perfecter includes: a transfer cylinder (14); a blanket impression cylinder (11); a blanket cylinder (12); and an air blow (15) and suction chambers (23a to 23f), which are provided to prevent a sheet (W) from contacting with the blanket impression cylinder (11) after the sheet (W) is conveyed from the transfer cylinder (14) to the blanket impression cylinder (11) and before the sheet reaches a contact point between the blanket impression cylinder (11) and the blanket cylinder (12). In the perfecter, a camera (30) is provided to take images of the sheet (W) from the same direction as a cylinder shaft direction of the blanket impression cylinder (11) at a certain timing after the sheet (W) is conveyed to the blanket impression cylinder (11) from the transfer cylinder (14) and before printing on the sheet (W) by the blanket impression cylinder (11) and the blanket cylinder (12) is finished.

### TECHNICAL FIELD

The present invention relates to a sheet monitor for a perfecter.

### BACKGROUND ART

As an offset perfecter, there is one disclosed in Patent Literature 1, for example.

As shown in FIGS. 9 and 10, in the offset perfecter in Patent Document 1, a pattern transferred onto a blanket surface of a blanket impression cylinder 100 from a plate cylinder 101 and a pattern transferred onto a blanket surface of a blanket cylinder 103 from a plate cylinder 102 are simultaneously printed, at a contact point between the blanket impression cylinder 100 and the blanket cylinder 103, respectively on both sides of a sheet W held on the blanket impression cylinder 100.

However, when the sheet W conveyed to the blanket impression cylinder 100 from a transfer cylinder 104 comes into contact with the blanket impression cylinder 100 upstream of the contact point, a pattern transferred onto the blanket impression cylinder 100 is partially transferred onto the sheet W from a portion in contact with the sheet W, and then is entirely printed on the sheet W under a printing pressure at the contact point between the blanket impression cylinder 100 and the blanket cylinder 103. As a result, the same pattern is printed twice on the sheet W. There is no problem when those patterns printed thereon are perfectly aligned with each other. However, it is a common case that the patterns are printed while being shifted from each other. Thus, the sheet is wasted.

Therefore, the offset perfecter in Patent Document 1 is configured to suction the sheet W in a direction separating from the blanket impression cylinder 100 by suction chambers 105a, 105b and 105c, and to blow air into between the sheet W and the blanket impression cylinder 100 by an air nozzle 106. Accordingly, the sheet W conveyed to the blanket impression cylinder 100 from the transfer cylinder 104 is separated from the blanket impression cylinder 100 so as not to come into contact with the blanket impression cylinder 100 upstream of the contact point between the blanket impression cylinder 100 and the blanket cylinder 103.

### CITATION LIST

[Patent Literature 1]

Japanese Patent Application Publication No. 2001-260319

### SUMMARY OF INVENTION

### [Technical Problem]

However, in the method described above, an operator sets a suction force (vacuum pressure) of the suction chambers 105a to 105c and a blow air pressure of the air nozzle 106 based on his/her experience. Thus, different types of the sheet W to be set, instability of the sheet W or the like may bring the sheet W into contact with the blanket impression cylinder 100. As a result, the problem as described above may occur.

Therefore, the following measures have heretofore been taken. Specifically, the operator periodically picks up a printed product to check if a printing failure is caused by printing twice. Then, when the failure has occurred, the operator adjusts the suction force (vacuum pressure) of the suction chambers 105a to 105c or the blow air pressure of the air nozzle 106. However, since the conventional measures require the operator to pick up and check the printed product, the measures are burdensome to the operator. Moreover, it is inevitable to waste all printed products produced after the failure occurs and before the printed product is picked up by the operator. This results in a large amount of waste sheets.

Therefore, it is an object of the present invention to solve the foregoing problems by allowing an operator to monitor in real time a behavior of a sheet in an installation region of sheet contact preventing means.

### [Solution to Problem]

An aspect of the present invention provides a sheet monitor for a perfecter, including: a first cylinder rotatably supported and provided with a first holding unit which holds a conveying direction leading end of a sheet; a second cylinder rotatably supported and provided with a second holding unit which holds the sheet received from the first holding unit of the first cylinder and with members disposed on a circumferential surface thereof and configured to print on one side of the sheet; a third cylinder rotatably supported and provided with members disposed on a circumferential surface thereof and configured to print on the other side of the sheet; and sheet contact preventing means provided to prevent the sheet from coming into contact with the second cylinder after the sheet is conveyed to the second cylinder from the first cylinder and before printing on the sheet is started by the second cylinder and the third cylinder. The sheet monitor includes imaging means provided to take an image of the sheet from the same direction as a cylinder shaft direction of the second cylinder at a certain timing after the sheet is conveyed to the second cylinder from the first cylinder and before printing on the sheet by the second cylinder and the third cylinder is finished.

Moreover, the sheet monitor for a perfecter further includes suction members separating the sheet from the second cylinder at least at a certain point after the sheet is conveyed to the second cylinder from the first cylinder and before printing on the sheet by the second cylinder and the third cylinder is finished, and in the sheet monitor for a perfecter, the imaging means takes an image of a range in which the sheet is suctioned by the suction members.

Moreover, in the sheet monitor for a perfecter, the imaging means takes an image of a range including an upstream side, in a sheet conveying direction, of the range in which the sheet is suctioned by the suction members.

Moreover, in the sheet monitor for a perfecter, the imaging means takes an image once for each rotation of the perfecter.

Moreover, in the sheet monitor for a perfecter, the imaging means takes every image at a perfecter rotation phase different from that of the image immediately before taken.

Moreover, in the sheet monitor for a perfecter, the imaging means takes every image at a later point in the perfector rotation phase than that of the image immediately before taken.

Moreover, the sheet monitor for a perfecter further includes a display, and in the sheet monitor for a perfecter, the display displays images, taken by the imaging means, in chronological order.

Moreover, in the sheet monitor for a perfecter, the display is provided in an operation stand operated by an operator.

### [Advantageous Effects of Invention]

According to the present invention having the above configuration, based on the images taken by the imaging means, the operator can monitor in real time the behavior of the sheet in the installation region of the sheet contact preventing means. Thus, the operator can promptly make a subsequent response. As a result, burden on the operator can be reduced and waste sheets can be reduced.

Moreover, the suction members are provided as the sheet contact preventing means and the imaging means takes an image of a range in which the sheet is suctioned by the suction members. Thus, the behavior of the sheet can be accurately monitored.

Moreover, the imaging means takes an image of a range on an upstream side in a sheet conveying direction of the sheet, in which the sheet is suctioned by the suction members. Thus, the behavior of the sheet can be more accurately monitored.

Moreover, the imaging means takes an image once for each rotation of the perfecter. Thus, recognition of images is facilitated unlike the case where one sheet is imaged more than once (so-called continuously shot) under high-speed rotation of the perfecter.

Moreover, the imaging means takes every image at a perfecter rotation phase different from that of the image immediately before taken. Thus, the behavior of the sheet can be comprehensively grasped.

Moreover, the imaging means takes every image at a later point in the perfecter rotation phase than that of the image immediately before taken. Thus, the behavior of the sheet can be recognized along the flow thereof. As a result, the operator can easily recognize the behavior.

Moreover, the display is provided to display the images taken by the imaging means in chronological order. Thus, the behavior of the sheet can be displayed as so-called frame advance images on the display. As a result, the operator can easily recognize the behavior.

Moreover, since the display is provided in the operation stand operated by the operator, monitoring by the operator is facilitated.

### BRIEF DESCRIPTION OF DRAWINGS

FIG. 1 is a schematic configuration diagram of a printing unit in an offset perfecter according to an embodiment of the present invention.

FIG. 2 is a view showing a layout of fans in suction chambers.

FIG. 3 is an explanatory view of a monitor (touch panel) in an operation stand.

FIG. 4A is an explanatory view of an image showing a good behavior of a sheet.

FIG. 4B is an explanatory view of an image showing a bad behavior of a sheet.

FIG. 5 is an explanatory view of good and bad samples having different sheet behaviors.

FIG. 6A is a block diagram of a control device.

FIG. 6B is a block diagram of the control device.

FIG. 7A is a flowchart showing operations of the control device.

FIG. 7B is a flowchart showing operations of the control device.

FIG. 7C is a flowchart showing operations of the control device.

FIG. 7D is a flowchart showing operations of the control device.

FIG. 8A is a flowchart showing operations of the control device.

FIG. 8B is a flowchart showing operations of the control device.

FIG. 8C is a flowchart showing operations of the control device.

FIG. 9 is an overall side view of a conventional offset perfecter.

FIG. 10 is an enlarged view of a main part of a printing unit in the conventional offset perfecter.

### DESCRIPTION OF EMBODIMENTS

With reference to the drawings, a sheet monitor for a perfector according to the present invention will be described in detail below based on an embodiment.

### EXAMPLES

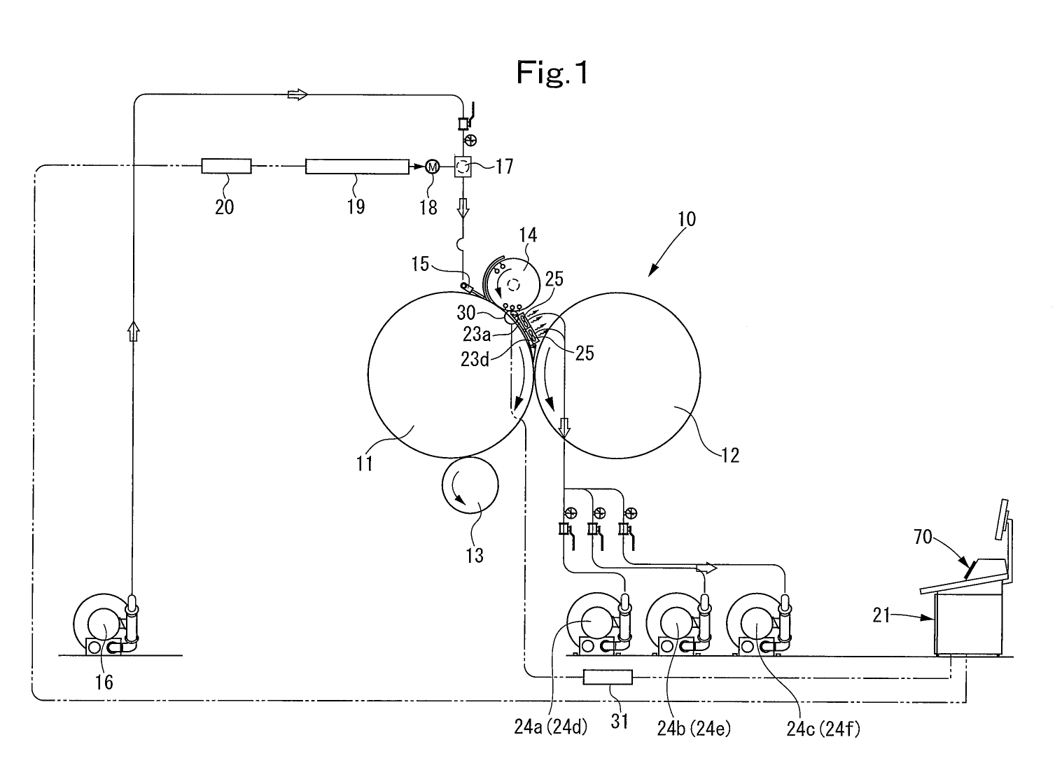

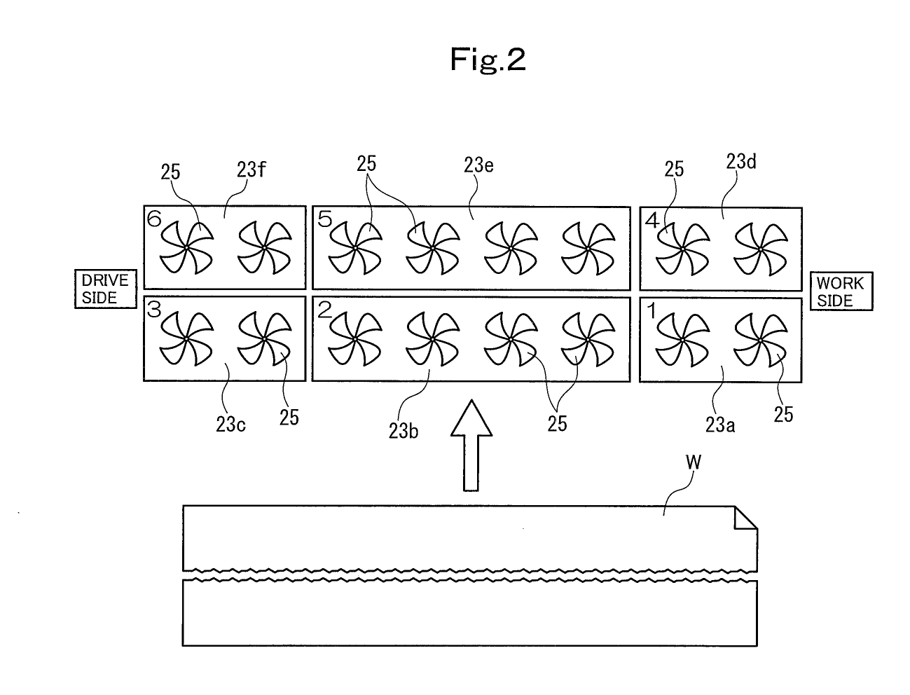

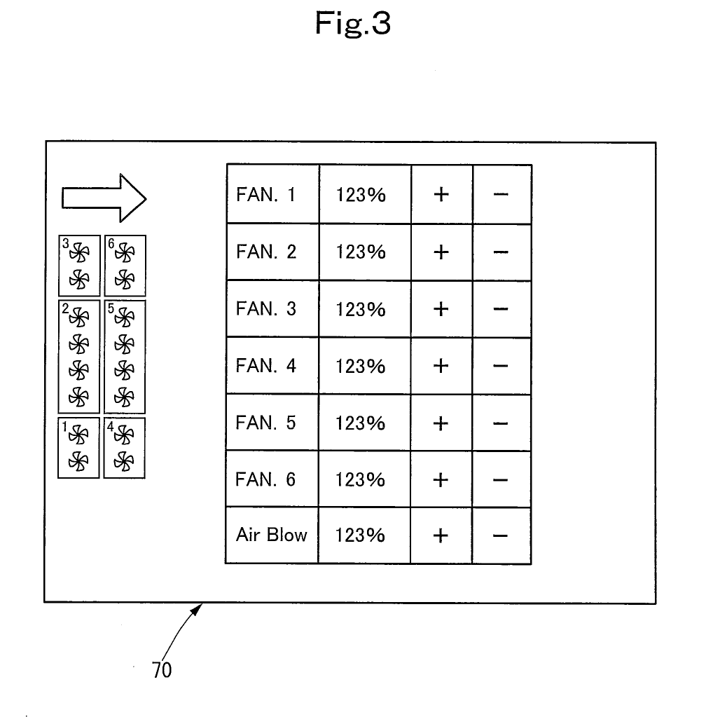

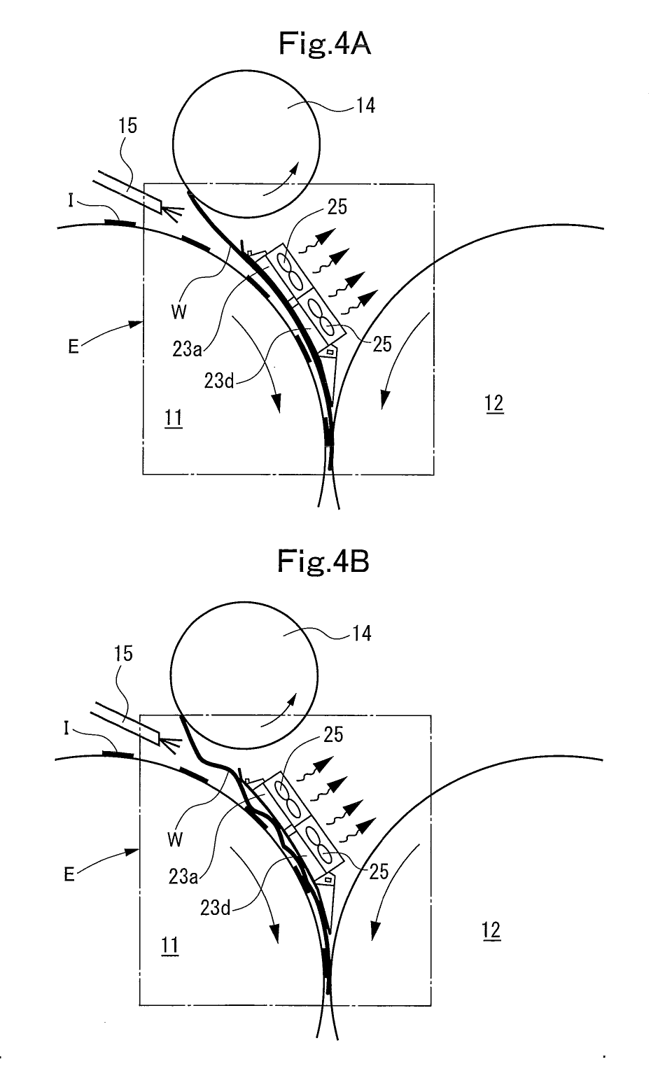

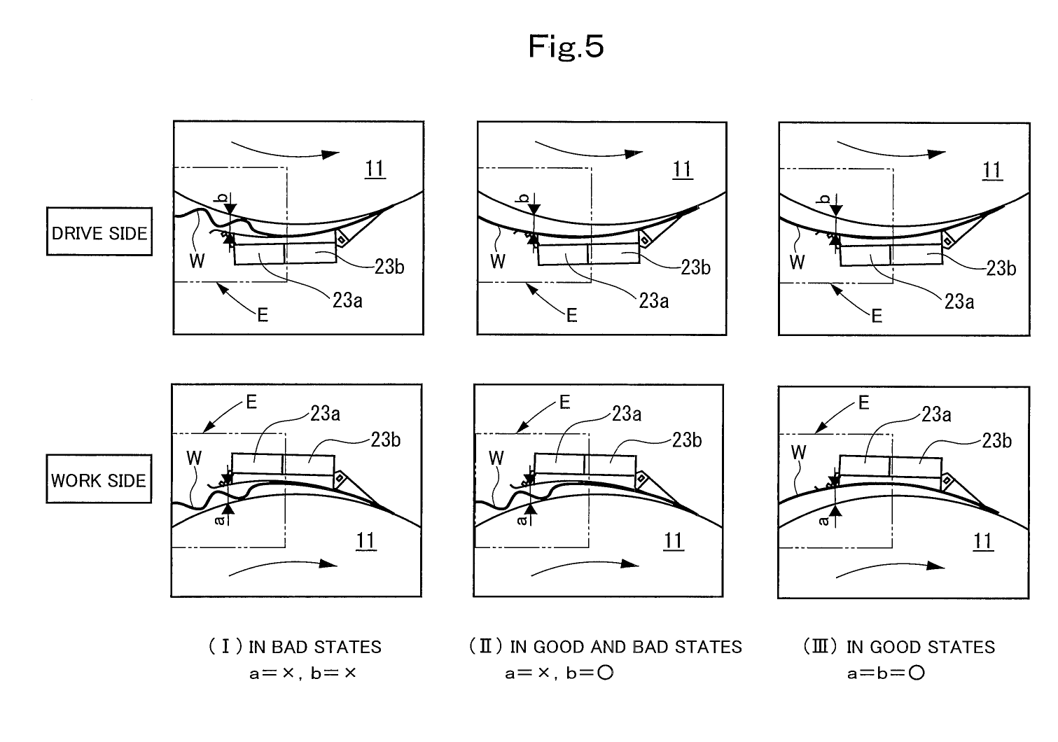

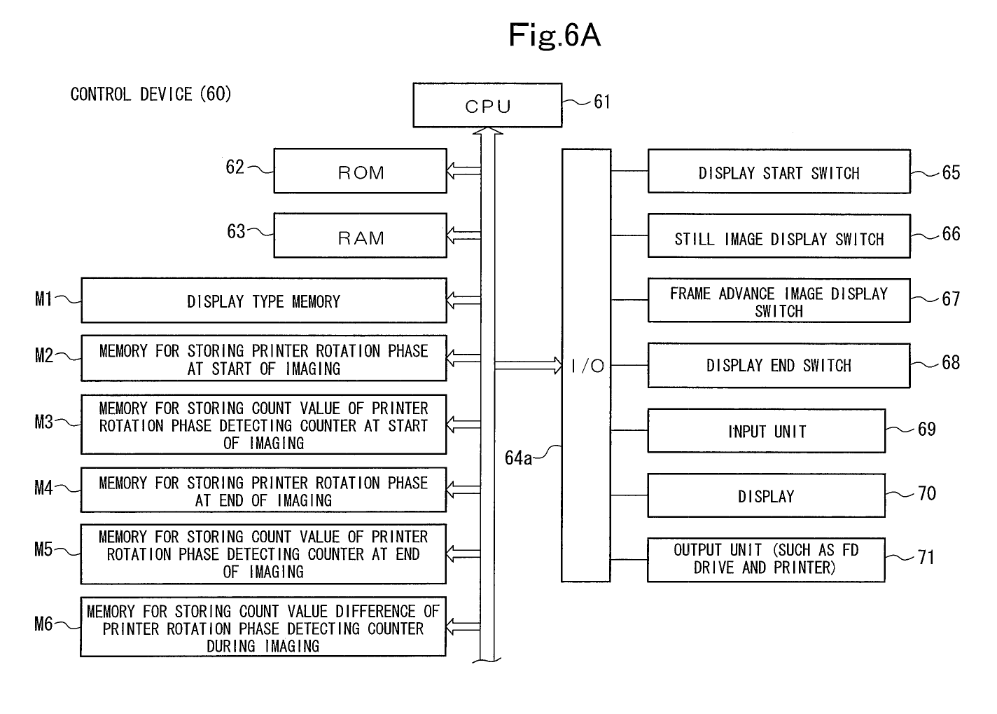

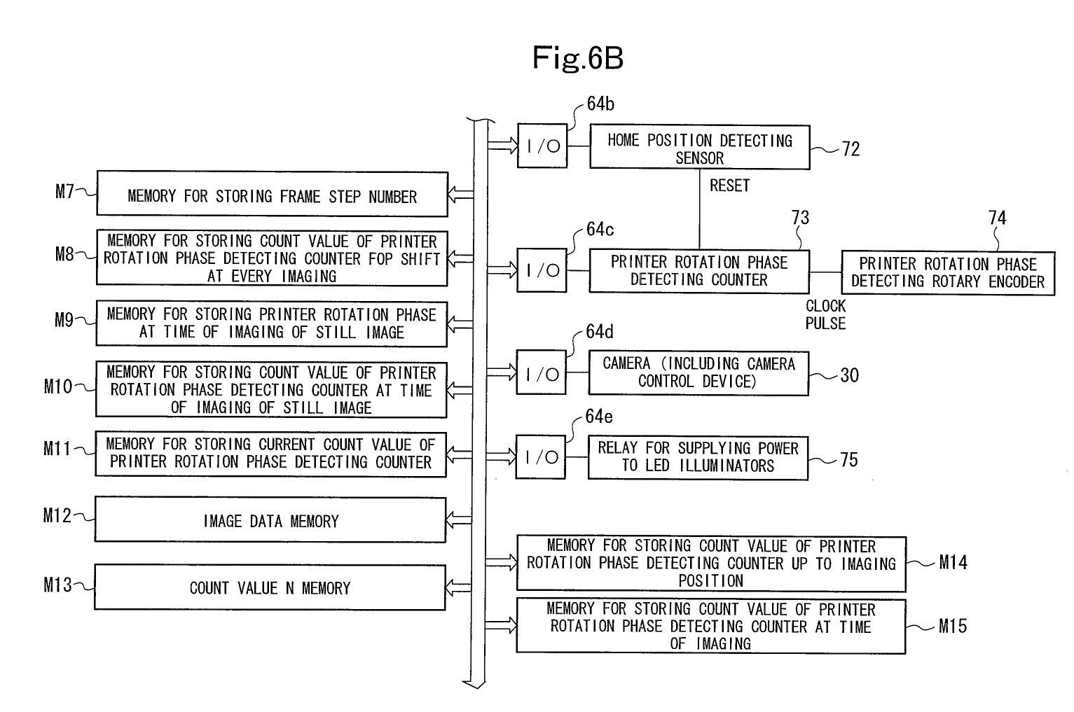

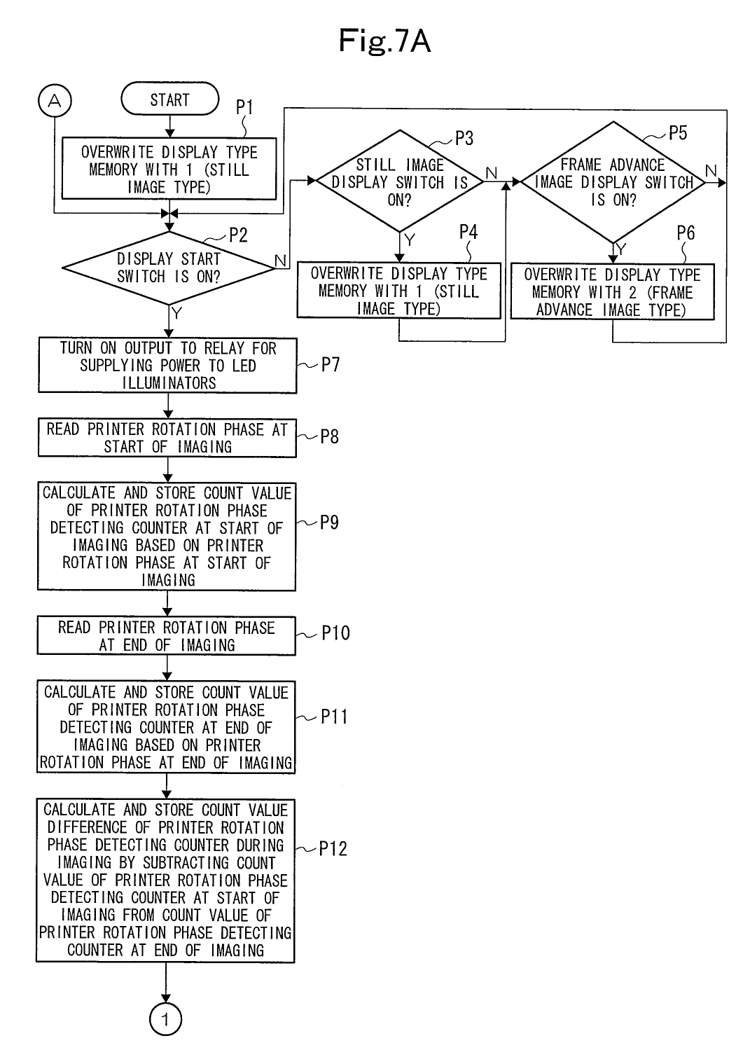

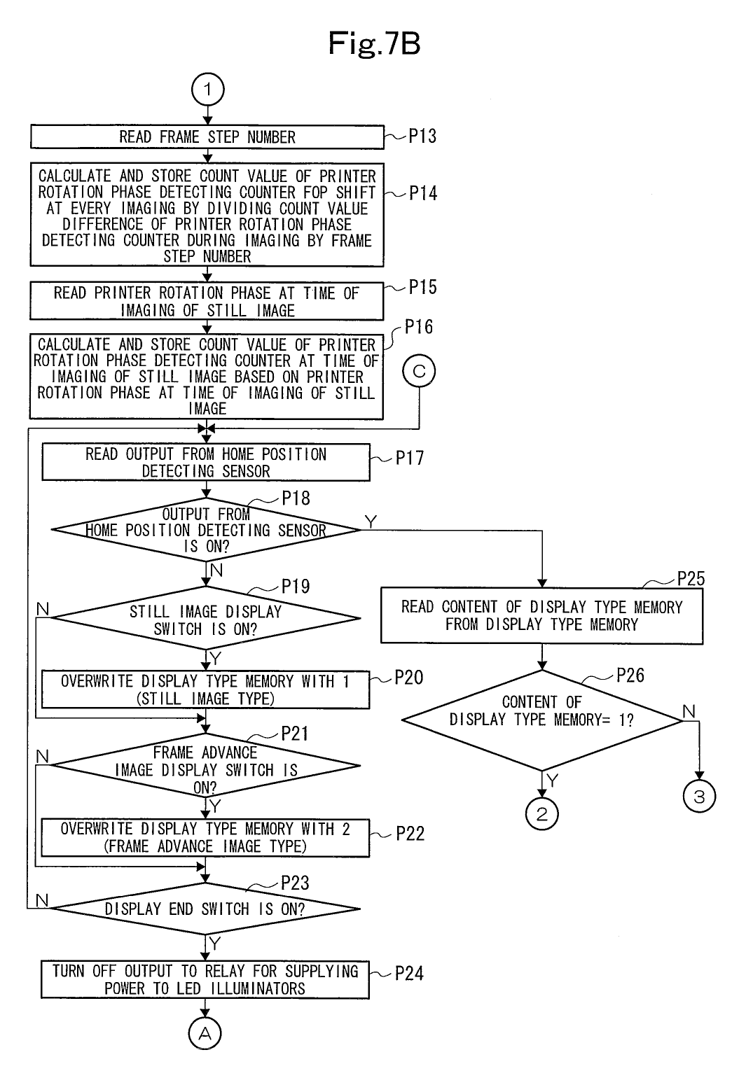

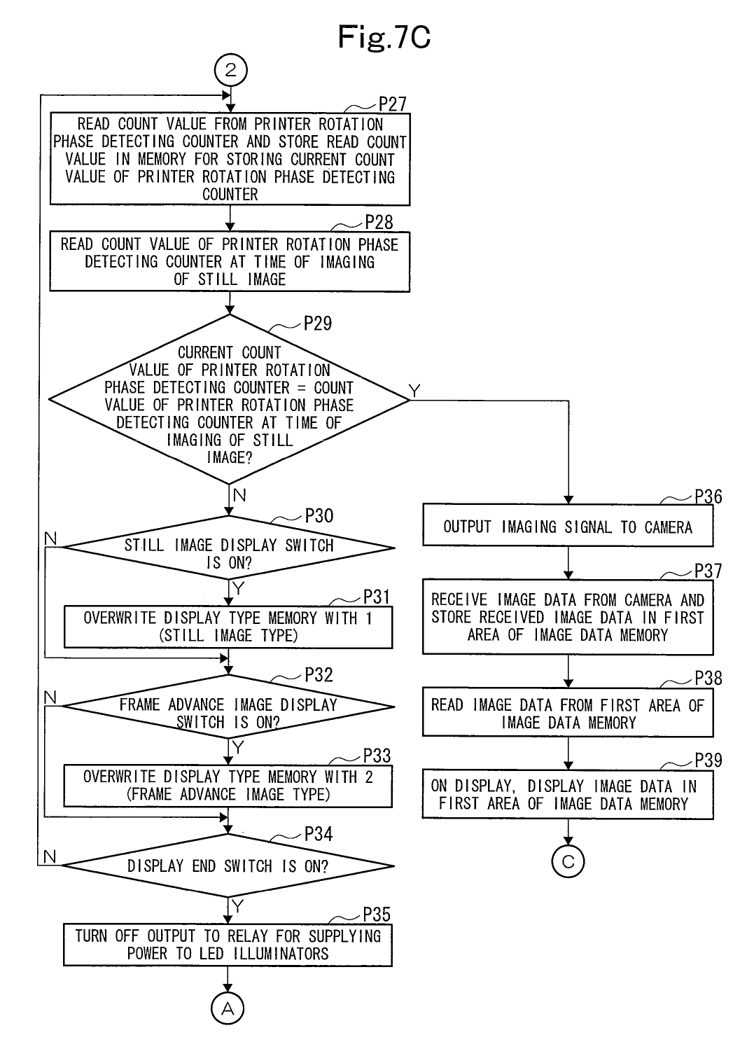

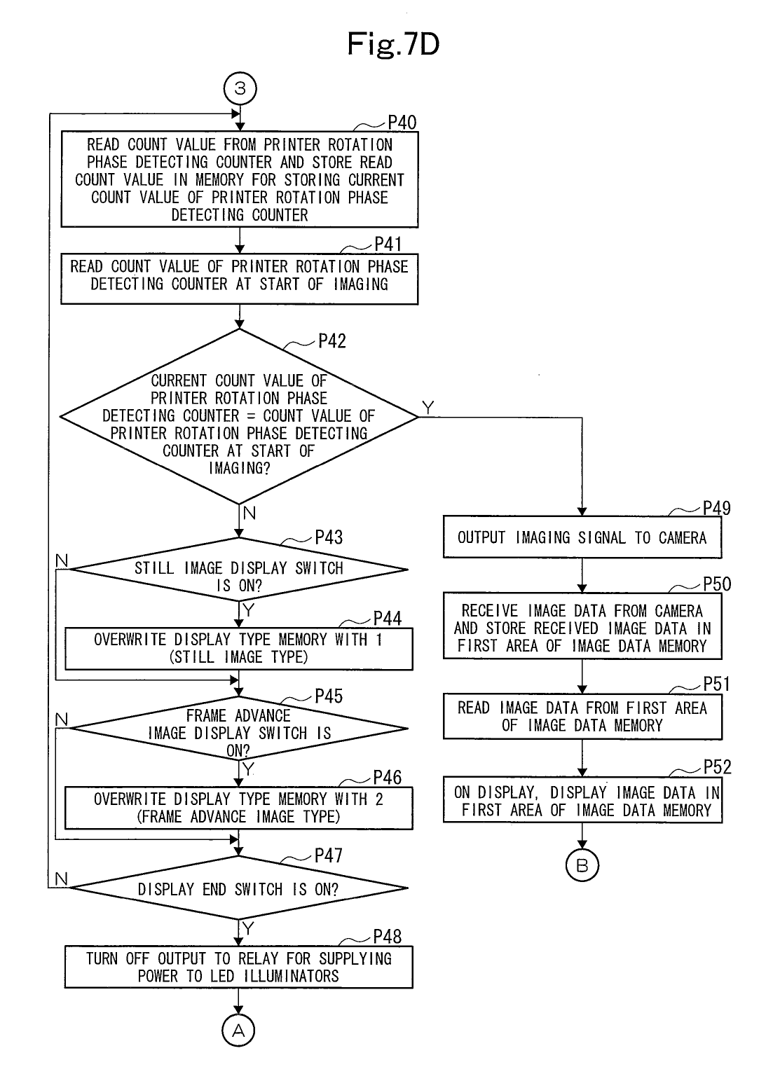

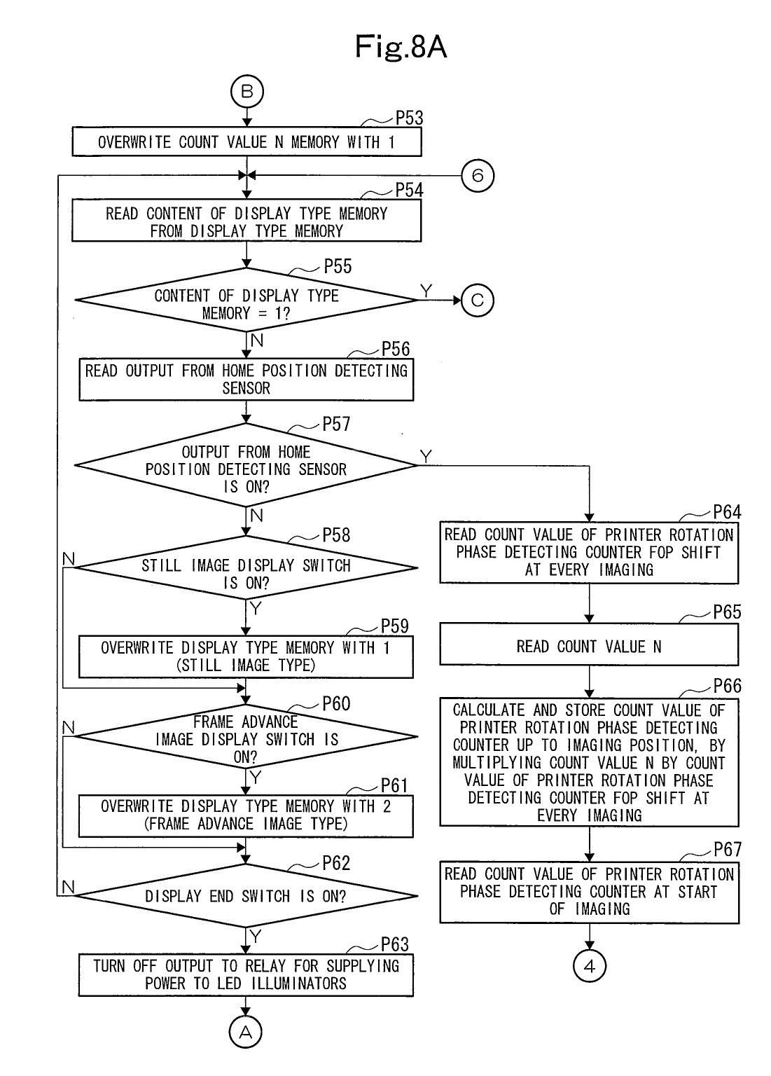

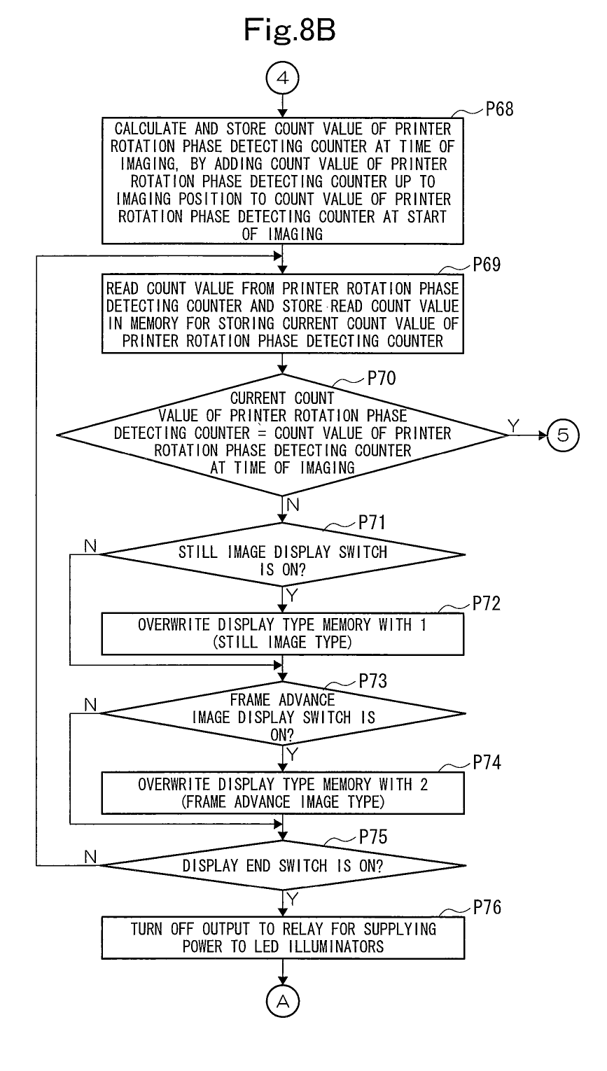

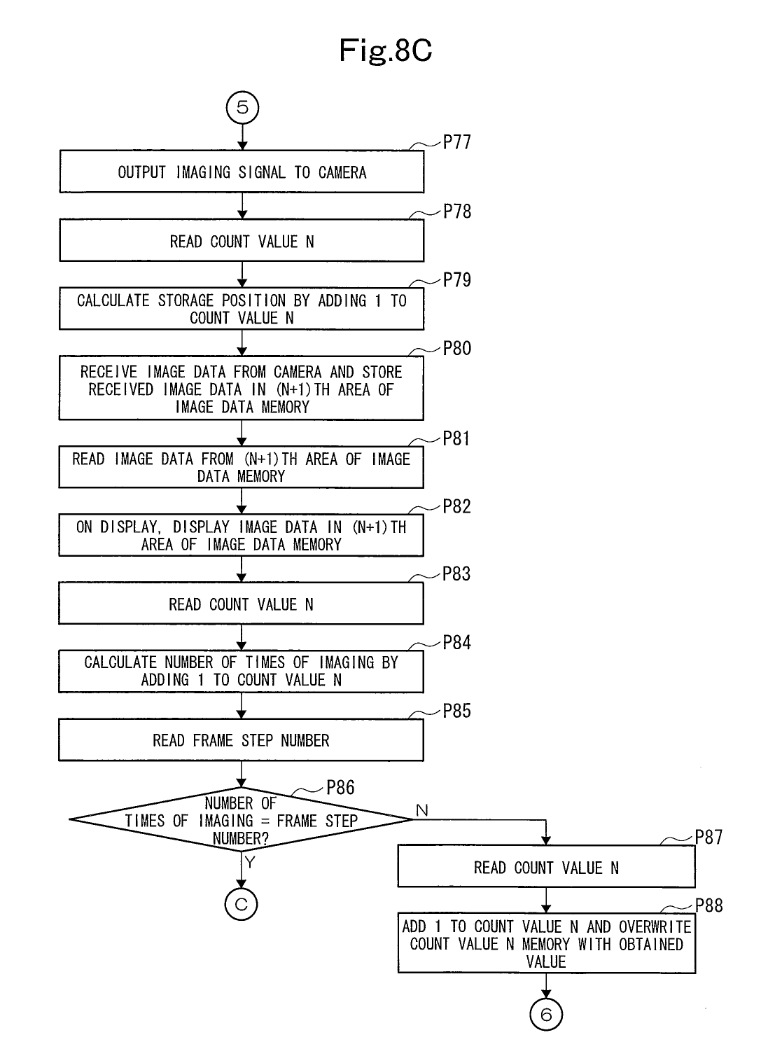

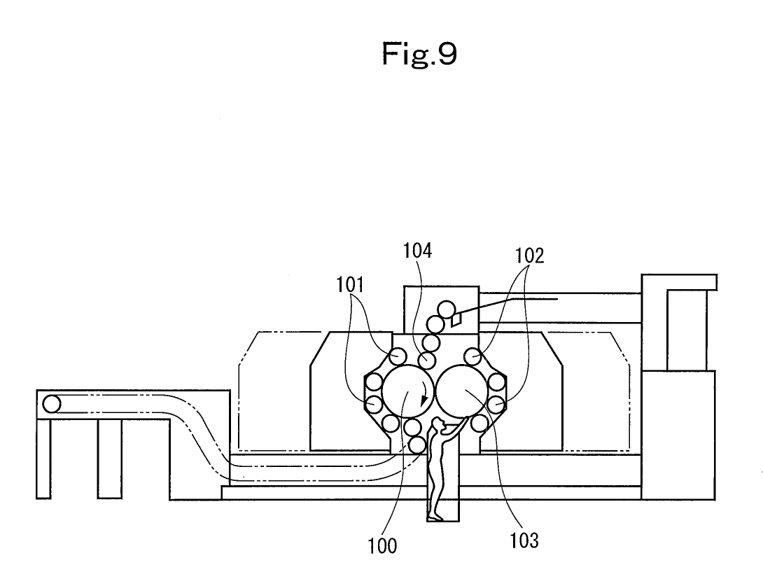

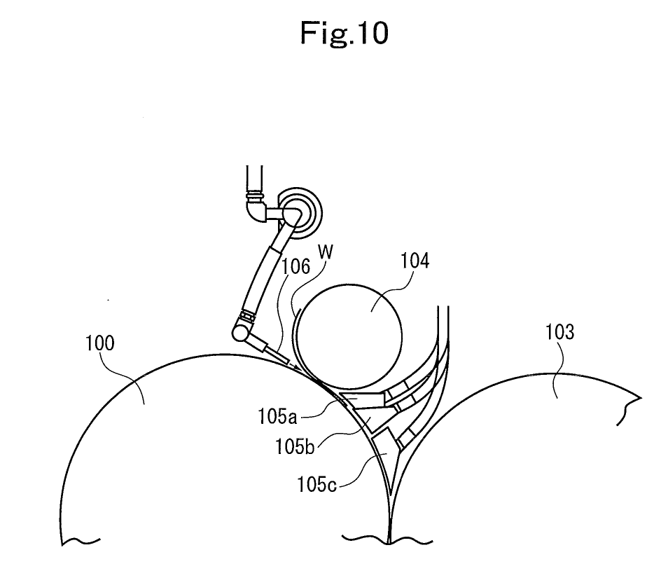

FIG. 1 is a schematic configuration diagram of a printing unit in an offset perfecter according to an embodiment of the present invention. FIG. 2 is a view showing a layout of fans in suction chambers. FIG. 3 is an explanatory view of a monitor (touch panel) in an operation stand. FIG. 4A is an explanatory view of an image showing a good behavior of a sheet. FIG. 4B is an explanatory view of an image showing a bad behavior of a sheet. FIG. 5 is an explanatory view of good and bad samples having different sheet behaviors. FIGS. 6A and 6B are block diagrams of a control device. FIGS. 7A to 7D are flowcharts showing operations of the control device. FIGS. 8A to 8C are flowcharts showing operations of the control device.

As shown in FIG. 1, in a printing unit 10 in the offset perfecter, a blanket impression cylinder (second cylinder) 11 provided with a sheet gripping device (second holding unit) and a blanket cylinder (third cylinder) 12 provided with no sheet gripping device are horizontally supported and circumferential surfaces thereof face each other.

On the circumferential surface of the blanket impression cylinder 11, unillustrated multiple plate cylinders (members) are arranged. Moreover, on the circumferential surface of the blanket cylinder 12, unillustrated multiple plate cylinders (members) are also arranged. An unillustrated ink unit is movably provided so as to come close to or separate from the plate cylinders. The ink unit can supply ink and water in a contact state with the plate cylinders.

Below the blanket impression cylinder 11, a transfer cylinder 13 is provided, which includes a sheet gripping device and conveys a sheet W (see FIGS. 2, 4A and 4B) to an unillustrated delivery cylinder.

Moreover, above the blanket impression cylinder 11, a transfer cylinder (first cylinder) 14 is provided, which includes a sheet gripping device (first holding unit) and conveys the sheet W to the blanket impression cylinder 11 from an unillustrated register.

Therefore, the sheet fed by an unillustrated feeder and positioned by the register is conveyed along a path indicated by arrows in FIG. 1, in other words, along the respective circumferential surfaces of the transfer cylinder 14, the blanket impression cylinder 11, the transfer cylinder 13 and the delivery cylinder. The sheet is subjected to printing when passing downward through a contact point between the blanket impression cylinder 11 and the blanket cylinder 12.

Moreover, as a device for guiding the sheet W, the transfer cylinder 14 is slightly separated from the blanket impression cylinder 11 within a range in which a gripping change of the sheet W can be made by the blanket impression cylinder 11. Moreover, a peripheral speed of the transfer cylinder 14 is set slightly higher than that of the blanket impression cylinder 11.

Moreover, an air blow (sheet contact preventing means) 15 for blowing air between the sheet W and the circumferential surface of the blanket impression cylinder 11 is provided upstream of a gripping change point between the transfer cylinder 14 and the blanket impression cylinder 11.

In the middle of an air pipe communicating with the air blow 15 and a pressure air supply source (such as a compressor) 16, a rotary valve 17 is provided. A drive motor 18 of the rotary valve 17 is connected to an operation stand 21 through a rotary encoder 19 and an amplifier 20. A display (also serving as a touch panel) 70 such as a monitor and a display is attached to the operation stand 21.

Therefore, a degree of opening of the rotary valve 17 is adjusted by operating buttons (see FIG. 3) on the display 70. Thus, a blow air pressure (air amount) of the air blow 15 can be adjusted.

Moreover, as shown in FIG. 2, suction chambers (suction members: sheet contact preventing means) 23a to 23f are provided between the transfer cylinder 14 and the blanket cylinder 12 along the circumferential surface of the blanket impression cylinder 11. The suction chambers are formed of six zones in total, which are formed by being divided into two sections in a sheet flow direction and into three sections in a sheet width direction. The suction chambers 23a to 23f are connected to negative-pressure sources (vacuum pumps or the like) 24a to 24f, respectively.

A predetermined number of fans 25 are provided in each of the suction chambers 23a to 23f formed of six zones. The fans 25 are also connected to the operation stand 21. Therefore, a rotation speed of the fans 25 in each zone is adjusted by operating buttons (see FIG. 3) on the display 70. Thus, a suction force (vacuum pressure) in each zone can be adjusted.

According to the above configuration, when the sheet W is conveyed to the contact point (printing point) between the blanket impression cylinder 11 and the blanket cylinder 12 after the gripping change is made from the transfer cylinder 14 to the blanket impression cylinder 11, the sheet W moves on a guide surface while being suctioned by the suction chambers 23a to 23f. Thus, the sheet W is conveyed to the printing point without coming into contact with the circumferential surface of the blanket impression cylinder 11.

Moreover, air enters between the sheet W subjected to the gripping change and the circumferential surface of the blanket impression cylinder 11 from the air blow 15. Thus, the sheet W does not come into contact with the circumferential surface of the blanket impression cylinder 11. Moreover, since the sheet W is pushed onto the guide surface of the suction chambers 23a to 23f by the air, the sheet is easily suctioned. Furthermore, since blowing of the air is stopped for a trailing edge of the sheet, instability of the trailing edge of the sheet is prevented.

Moreover, a camera (imaging means) 30 is provided together with illumination means such as an unillustrated LED illuminator and is connected to the operation stand 21 through an amplifier 31. Specifically, the camera 30 takes an image of the sheet W in the same direction as a cylinder shaft direction of the blanket impression cylinder 11 at a certain timing from when the sheet W is conveyed to the blanket impression cylinder 11 from the transfer cylinder 14 to when printing on the sheet W by the blanket impression cylinder 11 and the blanket cylinder 12 is finished.

Specifically, the camera 30 takes an image of a range (see an imaging range E shown in FIGS. 4A and 4B) in which the sheet W is suctioned by the suction chambers 23a to 23f described above. The camera 30 may preferably take an image of a range (see an imaging range E shown in FIG. 5) on an upstream side in a sheet conveying direction of the sheet W, in which the sheet W is suctioned by the suction chambers 23a to 23f, particularly, a range including a trailing edge of the sheet.

As the camera 30, a small monochrome camera with an electronic shutter or the like is used, which realizes high resolution and fast readout, for example. Moreover, the camera 30 and the LED illuminator are supported by a frame with brackets or the like, and may preferably be provided so as to allow fine adjustment of a shooting position and a shooting angle of the camera 30 or an illuminating position and an illuminating angle of the LED illuminator.

Note that, in this embodiment, description will be given of an example where the camera 30 and the LED illuminator are provided on only a work side of the printer. However, needless to say, the camera 30 and the LED illuminator may be provided on both a drive side and the work side of the printer.

The camera 30 and the LED illuminator are connected to a control device 60 to be described later, which is built in the operation stand 21. The control device 60 controls an imaging timing for the camera 30, controls switching of display types when an image taken by the camera 30 is displayed on the display 70, and controls power supply to the LED illuminator. Therefore, the camera 30, the LED illuminator, the control device 60, the display 70 and the like form the sheet monitor for the perfecter.

The operator monitors in real time the images displayed on the display 70 and determines OK when the sheet W is stably suctioned by the suction chambers 23a to 23f and conveyed along the guide surface of the suction chambers 23a to 23f and thereby there is no risk that ink I on the blanket impression cylinder 11 will adhere to the sheet W at an upstream side in a rotation direction of the contact point between the blanket impression cylinder 11 and the blanket cylinder 12 as shown in FIG. 4A, for example. On the other hand, the operator determines NG when instability of the sheet W, which is caused when the sheet W is not stably suctioned by the suction chambers 23a to 23f and conveyed along the guide surface of the suction chambers 23a to 23f, causes a risk of the ink I adhering to the sheet W at the upstream side in the rotation direction of the contact point as shown in FIG. 4B. In the case of NG, the blow air pressure (air amount) of the air blow 15 described above or the rotation speed of the fans 25 in each of the zones of the suction chambers 23a to 23f is adjusted until the state of FIG. 4A is obtained.

FIG. 5 shows examples of good and bad pattern samples in a case where the cameras 30 are provided on both the drive side and work side of the printer. The states of (I) and (II) where instability of the sheet W occurs on both the drive side and the work side represent a bad situation where a printing trouble occurs. In FIG. 5, degrees of the instability on both the work side and drive side are expressed as a and b, respectively. In this case, the rotation speed of the fans 25 in each of the zones of the suction chambers 23a to 23f is adjusted until the instability is eliminated. The adjustment results in a good situation where the sheet W is suctioned by the suction chambers 23a to 23f on both of the sides as shown in (III).

As shown in FIGS. 6A and 6B, the control device 60 includes a CPU 61, a ROM 62, a RAM 63 and I/O units 64a to 64e, which are connected to each other via a bus line. A display type memory M1, a memory M2 for storing a printer rotation phase at the start of imaging, a memory M3 for storing a count value of a printer rotation phase detecting counter at the start of imaging, a memory M4 for storing a printer rotation phase at the end of imaging, and a memory M5 for storing a count value of the printer rotation phase detecting counter at the end of imaging are connected to the bus line.

A memory M6 for storing a count value difference of the printer rotation phase detecting counter during imaging, a memory M7 for storing a frame step number, a memory M8 for storing a count value of the printer rotation phase detecting counter for shift at every imaging, a memory M9 for storing a printer rotation phase at the time of imaging of a still image, and a memory M10 for storing a count value of the printer rotation phase detecting counter at the time of imaging of the still image are further connected to the bus line.

A memory M11 for storing a count value of a counter for detecting a current printer rotation phase, an image data memory M12, a count value N memory M13, a memory M14 for storing a count value of the printer rotation phase detecting counter up to an imaging position, and a memory M15 for storing a count value of the printer rotation phase detecting counter at the time of imaging are further connected to the bus line.

A display start switch 65, a still image display switch 66, a frame advance image display switch 67, a display end switch 68, an input unit 69 such as a keyboard, the display 70 such as the CRT and the display, and an output unit 71 such as a printer and a floppy disk (registered trademark) drive are connected to the I/O unit 64a.

A home position detecting sensor 72 is connected to the I/O unit 64b. Note that the home position detecting sensor 72 is formed of a photoelectric sensor or the like and is attached to a rotary member of the perfecter so as to generate a pulse for every rotation of the perfecter. Here, one rotation of the perfecter means a rotation from start of printing on one sheet W to start of printing on a next sheet W.

A printer rotation phase detecting rotary encoder 74 is connected to the I/O unit 64c through a printer rotation phase detecting counter 73. The printer rotation phase detecting counter 73 is also connected to the home position detecting sensor 72. Note that the printer rotation phase detecting rotary encoder 74 is attached to the rotary member of the perfecter so as to be rotated once for every rotation of the perfecter.

The camera (including a camera control device) 30 is connected to the I/O unit 64d.

A relay 75 for supplying power to the LED illuminators is connected to the I/O unit 64e.

Control operations executed by the control device 60 as described above will be described in detail with reference to FIGS. 7A to 7D and FIGS. 8A to 8C.

First, after the display type memory M1 is overwritten with 1 (still image type) in Step P1, it is determined whether or not the display start switch 65 is ON in Step P2. Here, if a result of the determination is positive, the operation moves to Step P7 to be described later. On the other hand, if the result of the determination is negative, it is determined whether or not the still image display switch 66 is ON in Step P3.

Next, if a result of the determination in Step P3 is positive, the display type memory M1 is overwritten with 1 (still image type) in Step P4. Thereafter, it is determined whether or not the frame advance image display switch 67 is ON in Step P5. On the other hand, if the result of the determination in Step P3 is negative, the operation immediately moves to Step PS.

Thereafter, if a result of the determination in Step P5 is positive, the display type memory M1 is overwritten with 2 (frame advance image type) in Step P6. Thereafter, the operation returns to Step P2. On the other hand, if the result of the determination in Step P5 is negative, the operation immediately returns to Step P2.

When an output to the relay 75 for supplying power to the LED illuminators is turned ON in Step P7 described above, a printer rotation phase at the start of imaging is read from the memory M2 in Step P8. Thereafter, a count value of the printer rotation phase detecting counter at the start of imaging is calculated based on the printer rotation phase at the start of imaging and stored in the memory M3 in Step P9.

Subsequently, after a printer rotation phase at the end of imaging is read from the memory M4 in Step P10, a count value of the printer rotation phase detecting counter at the end of imaging is calculated based on the printer rotation phase at the end of imaging and stored in the memory M5 in Step P11.

Next, in Step P12, a count value difference of the printer rotation phase detecting counter during imaging is calculated by subtracting the count value of the printer rotation phase detecting counter at the start of imaging from the count value of the printer rotation phase detecting counter at the end of imaging, and is stored in the memory M6. Thereafter, in Step P13, a frame step number is read from the memory M7.

Subsequently, in Step P14, a count value of a printer rotation phase detecting counter for shift at every imaging is calculated by dividing the count value difference of the printer rotation phase detecting counter during imaging by the frame step number, and is stored in the memory M8. Thereafter, in Step P15, a printer rotation phase at the time of imaging of a still image is read from the memory M9. Note that the perfecter rotation phase at the time of imaging of the still image is a rotation phase in which the trailing edge of the sheet W suctioned by the suction chambers 23a to 23f can be imaged as shown in FIG. 4A.

Next, in Step P16, a count value of the printer rotation phase detecting counter at the time of imaging of the still image is calculated based on the printer rotation phase at the time of imaging of the still image, and is stored in the memory M10. By the operation flow described above, the imaging timing for the cameras 30A and 30B of the both display types (the still image type and the frame advance image type) is initialized.

Next, after an output from the home position detecting sensor 72 is read in Step P17, it is determined whether or not the output from the home position detecting sensor 72 is ON in Step P18. If a result of the determination is positive, the operation moves to Step P25 to be described later. On the other hand, if the result of the determination is negative, it is determined whether or not the still image display switch 66 is ON in Step P19.

Next, if a result of the determination in Step P19 is positive, the display type memory M1 is overwritten with 1 (still image type) in Step P20. Thereafter, it is determined whether or not the frame advance image display switch 67 is ON in Step P21. On the other hand, if the result of the determination in Step P19 is negative, the operation immediately moves to Step P21.

Thereafter, if a result of the determination in Step P21 is positive, the display type memory M1 is overwritten with 2 (frame advance image type) in Step P22. Thereafter, it is determined whether or not the display end switch 68 is ON in Step P23. On the other hand, if the result of the determination in Step P21 is negative, the operation immediately moves to Step P23.

If a result of the determination in Step P23 is positive, the output to the relay 75 for supplying power to the LED illuminators is turned OFF in Step P24 and the operation returns to Step P2. On the other hand, if the result of the determination in Step P23 is negative, the operation returns to Step P17.

Next, after a content of the display type memory M1 is read from the display type memory M1 in Step P25 described above, it is determined whether or not the content of the display type memory=1 in Step P26.

If a result of the determination in Step P26 is positive, a count value is read from the printer rotation phase detecting counter 73 in Step P27 and is stored in the memory M11 for storing a count value of a counter for detecting a current printer rotation phase. On the other hand, if the result of the determination in Step P26 is negative, the operation moves to Step P40 to be described later.

Next, after the count value of the printer rotation phase detecting counter at the time of imaging of the still image is read from the memory M10 in Step P28, it is determined in Step P29 whether or not the count value of the counter for detecting the current printer rotation phase is equal to the count value of the printer rotation phase detecting counter at the time of imaging of the still image.

If a result of the determination in Step P29 is positive, the operation moves to Step P36 to be described later. On the other hand, if the result of the determination in Step P29 is negative, it is determined whether or not the still image display switch 66 is ON in Step P30. If a result of the determination in Step P30 is positive, the display type memory M1 is overwritten with 1 (still image type) in Step P31. Thereafter, it is determined whether or not the frame advance image display switch 67 is ON in Step P32. On the other hand, if the result of the determination in Step P30 is negative, the operation immediately moves to Step P32.

If a result of the determination in Step P32 is positive, the display type memory M1 is overwritten with 2 (frame advance image type) in Step P33. Thereafter, it is determined whether or not the display end switch 68 is ON in Step P34. On the other hand, if the result of the determination in Step P32 is negative, the operation immediately moves to Step P34.

If a result of the determination in Step P34 is positive, the output to the relay 75 for supplying power to the LED illuminators is turned OFF in Step P35 and the operation returns to Step P2. On the other hand, if the result of the determination in Step P34 is negative, the operation returns to Step P27.

Next, an imaging signal is outputted to the camera 30 in Step P36 described above. Thereafter, in Step P37, image data is received from the camera 30 and is stored in a first area in the image data memory M12.

Subsequently, after the image data is read from the first area of the image data memory M12 in Step P38, the image data in the first area of the image data memory M12 is displayed on the display 70 in Step P39. Thereafter, the operation returns to Step P17.

When the content of the display type memory M1 is 1, in other words, when the still image type is selected as the display type, the loop including Steps P17, P18, P25 to P29 and P36 to P43 executed in this order allows the camera 30 to always takes images in the perfecter rotation phase at the time of imaging of the still image and also allows the display 70 to display those images. Thus, the image data is displayed on the display 70 as if still images were displayed thereon.

Next, in Step P40 described above, the count value is read from the printer rotation phase detecting counter 73 and is stored in the memory M11 for storing the count value of the counter for detecting the current printer rotation phase. Thereafter, in Step P41, the count value of the printer rotation phase detecting counter at the start of imaging is read from the memory M3.

Next, it is determined in Step P42 whether or not the count value of the counter for detecting the current printer rotation phase is equal to the count value of the printer rotation phase detecting counter at the start of imaging. If a result of the determination in Step P42 is positive, the operation moves to Step P49 to be described later. On the other hand, if the result of the determination in Step P42 is negative, it is determined whether or not the still image display switch 66 is ON in Step P43.

If a result of the determination in Step P43 is positive, the display type memory M1 is overwritten with 1 (still image type) in Step P44. Thereafter, it is determined whether or not the frame advance image display switch 67 is ON in Step P45. On the other hand, if the result of the determination in Step P43 is negative, the operation immediately moves to Step P45.

If a result of the determination in Step P45 is positive, the display type memory M1 is overwritten with 2 (frame advance image type) in Step P46. Thereafter, it is determined whether or not the display end switch 68 is ON in Step P47. On the other hand, if the result of the determination in Step P45 is negative, the operation immediately moves to Step P47.

If a result of the determination in Step P47 is positive, the output to the relay 75 for supplying power to the LED illuminators is turned OFF in Step P48 and the operation returns to Step P2. On the other hand, if the result of the determination in Step P47 is negative, the operation returns to Step P40.

Next, an imaging signal is outputted to the camera 30 in Step P49 described above. Thereafter, in Step P50, image data is received from the camera 30 and is stored in the first area in the image data memory M12.

Next, after the image data is read from the first area of the image data memory M12 in Step P51, the image data in the first area of the image data memory M12 is displayed on the display 70 in Step P52. Thereafter, the operation moves to Step P53 to be described later.

Next, after the count value N memory M13 is overwritten with 1 in Step P53 described above, a content of the display type memory M1 is read from the display type memory M1 in Step P54.

Thereafter, it is determined whether or not the content of the display type memory is equal to 1 in Step P55. If a result of the determination in Step P55 is positive, the operation returns to Step P17. On the other hand, if the result of the determination in Step P55 is negative, an output from the home position detecting sensor 72 is read in Step P56.

Subsequently, it is determined whether or not the output from the home position detecting sensor 72 is ON in Step P57. If a result of the determination in Step P57 is positive, the operation moves to Step P64 to be described later. On the other hand, if the result of the determination in Step P57 is negative, it is determined whether or not the still image display switch 66 is ON in Step P58.

Next, if a result of the determination in Step P58 is positive, the display type memory M1 is overwritten with 1 (still image type) in Step P59. Thereafter, it is determined whether or not the frame advance image display switch 67 is ON in Step P60. On the other hand, if the result of the determination in Step P58 is negative, the operation immediately moves to Step P60.

If a result of the determination in Step P60 is positive, the display type memory M1 is overwritten with 2 (frame advance image type) in Step P61. Thereafter, it is determined whether or not the display end switch 68 is ON in Step P62. On the other hand, if the result of the determination in Step P60 is negative, the operation immediately moves to Step P62.

If a result of the determination in Step P62 is positive, the output to the relay 75 for supplying power to the LED illuminators is turned OFF in Step P63 and the operation returns to Step P2. On the other hand, if the result of the determination in Step P62 is negative, the operation returns to Step P54.

Subsequently, in Step P64 described above, the count value of the printer rotation phase detecting counter for shift at every imaging is read from the memory M8. Thereafter, the count value N is read from the memory M13 in Step P65.

Next, in Step P66, a count value of the printer rotation phase detecting counter up to an imaging position is calculated by multiplying the count value N by the count value of the printer rotation phase detecting counter for shift at every imaging, and is stored in the memory M14. Thereafter, in Step P67, the count value of the printer rotation phase detecting counter at the start of imaging is read from the memory M3.

Next, in Step P68, a count value of the printer rotation phase detecting counter at the time of imaging is calculated by adding the count value of the printer rotation phase detecting counter up to the imaging position to the count value of the printer rotation phase detecting counter at the start of imaging, and is stored in the memory M15. Thereafter, in Step P69, a count value is read from the printer rotation phase detecting counter 73 and is stored in the memory M1 for storing a count value of the counter for detecting a current printer rotation phase.

Thereafter, it is determined in Step P70 whether or not the count value of the counter for detecting the current printer rotation phase is equal to the count value of the printer rotation phase detecting counter at the time of imaging. If a result of the determination in Step P70 is positive, the operation moves to Step P77 to be described later. On the other hand, if the result of the determination in Step P70 is negative, it is determined whether or not the still image display switch 66 is ON in Step P71.

If a result of the determination in Step P71 is positive, the display type memory M1 is overwritten with 1 (still image type) in Step P72. Thereafter, it is determined whether or not the frame advance image display switch 67 is ON in Step P73. On the other hand, if the result of the determination in Step P71 is negative, the operation immediately moves to Step P73.

If a result of the determination in Step P73 is positive, the display type memory M1 is overwritten with 2 (frame advance image type) in Step P74. Thereafter, it is determined whether or not the display end switch 68 is ON in Step P75. On the other hand, if the result of the determination in Step P73 is negative, the operation immediately moves to Step P75.

If a result of the determination in Step P75 is positive, the output to the relay 75 for supplying power to the LED illuminators is turned OFF in Step P76 and the operation returns to Step P2. On the other hand, if the result of the determination in Step P75 is negative, the operation returns to Step P69.

Next, after an imaging signal is outputted to the camera 30 in Step P77 described above, the count value N is read from the memory M13 in Step P78.

Thereafter, in Step P79, a storage position is calculated by adding 1 to the count value N. Subsequently, in Step P80, image data is received from the camera 30 and is stored in a (N+1)^{th} area in the image data memory M12.

Next, in Step P81, the image data is read from the (N+1)^{th} area in the image data memory M12. Thereafter, in Step P82, the image data in the (N+1)^{th} area in the image data memory M12 is displayed on the right side of the display 70.

After the count value N is read from the memory M13 in Step P83, the number of times of imaging is calculated by adding 1 to the count value N in Step P84.

Next, after the frame step number is read from the memory M7 in Step P85, it is determined whether or not the number of times of imaging is equal to the frame step number in Step P86.

If a result of the determination in Step P86 is positive, the operation returns to Step P17. On the other hand, if the result of the determination in Step P86 is negative, the count value N is read from the memory M13 in Step P87. Thereafter, in Step P88, 1 is added to the count value N and the count value N memory M13 is overwritten with the obtained value. Subsequently, the operation returns to Step P54. Thereafter, the above operation is repeated.

When the content of the display type memory M1 is 2, in other words, when the frame advance image type is selected as the display type, the loop including Steps P17, P18, P25, P26, P40 to P42, P49 to P57, P64 to P70 and P77 to P88 executed in this order allows images to be taken by the camera 30 by delaying a timing every time by a period corresponding to a fixed rotation phase and to be sequentially displayed on the display 70 in chronological order. Thus, the image data is displayed on the display 70 as if images were displayed frame by frame thereon. Moreover, the perfecter rotation phase for imaging the frame advance images includes a rotation phase approximately equal to the perfecter rotation phase at the time of imaging of the still image.

As described above, in this embodiment, based on the images taken by the cameras 30, the operator can monitor in real time the behavior (see FIGS. 4A and 4B) of the sheet W in the installation area of the air blow 15 and the suction chambers 23a to 23f in the printing unit.

Thus, the operator can promptly make a subsequent response (such as adjusting the blow air pressure (air amount) of the air blow 15 or the rotation speed of the fans 25 in each zone of the suction chambers 23a to 23f when the behavior is NG). As a result, burden on the operator can be reduced and waste sheets can be reduced.

Moreover, since the camera 30 takes an image of the range (see the imaging range E shown in FIGS. 4A and 4B) in which the sheet W is suctioned by the suction chambers 23a to 23f, the behavior of the sheet W can be accurately monitored. Note that, needless to say, the behavior of the sheet W can be more accurately monitored by the camera 30 taking an image of the range (see the imaging range E shown in FIG. 5) on the upstream side in the sheet conveying direction of the sheet W, in which the sheet W is suctioned by the suction chambers 23a to 23f.

Moreover, the camera 30 takes an image once for each rotation of the printer (in other words, for each sheet W). Thus, recognition of images is facilitated unlike the case where one sheet W is imaged more than once (so-called continuously shot) at multiple positions under high-speed rotation of the printer.

Moreover, the camera 30 shifts its imaging position at every imaging for each sheet W by taking every image at a later point in a printer rotation phase than that of the image immediately before taken. Thus, the behavior of the sheet W can be comprehensively grasped along the flow thereof. As a result, the operator can easily recognize the behavior.

Moreover, the display 70 is provided to display the images taken by the camera 30 in chronological order. Thus, the behavior of the sheet W can be displayed as so-called frame advance images on the display 70. As a result, the operator can easily recognize the behavior.

Moreover, since the display 70 is provided in the operation stand 21 operated by the operator, monitoring by the operator is facilitated.

Note that, needless to say, the present invention is not limited to the above embodiment and various changes, such as a structural change in the suction means, can be made without departing from the scope of the invention.

### REFERENCE SIGNS LIST

11 BLANKET IMPRESSION CYLINDER

12 BLANKET CYLINDER

13 TRANSFER CYLINDER

14 TRANSFER CYLINDER

15 AIR BLOW

21 OPERATION STAND

23a TO 23f SUCTION CHAMBER

15 FAN

30 CAMERA

60 CONTROL DEVICE

70 DISPLAY

W SHEET

1. A sheet monitor for a perfector, including: a first cylinder rotatably supported and provided with a first holding unit which holds a conveying direction leading end of a sheet; a second cylinder rotatably supported and provided with a second holding unit which holds the sheet received from the first holding unit of the first cylinder and with members disposed on a circumferential surface thereof and configured to print on one side of the sheet; a third cylinder rotatably supported and provided with members disposed on a circumferential surface thereof and configured to print on the other side of the sheet; and sheet contact preventing means provided to prevent the sheet from coming into contact with the second cylinder after the sheet is conveyed to the second cylinder from the first cylinder and before printing on the sheet is started by the second cylinder and the third cylinder, the sheet monitor comprising imaging means provided to take an image of the sheet from the same direction as a cylinder shaft direction of the second cylinder at a certain timing after the sheet is conveyed to the second cylinder from the first cylinder and before printing on the sheet by the second cylinder and the third cylinder is finished.

2. The sheet monitor for a perfecter according to claim 1, further comprising
suction members separating the sheet from the second cylinder at least at a certain point after the sheet is conveyed to the second cylinder from the first cylinder and before printing on the sheet by the second cylinder and the third cylinder is finished, wherein
the imaging means takes an image of a range in which the sheet is suctioned by the suction members.

3. The sheet monitor for a perfecter according to claim 2, wherein
the imaging means takes an image of a range including an upstream side, in a sheet conveying direction, of the range in which the sheet is suctioned by the suction members.

4. The sheet monitor for a perfecter according to claim 1, wherein
the imaging means takes an image once for each rotation of the perfecter.

5. The sheet monitor for a perfecter according to claim 4, wherein
the imaging means takes every image at a perfecter rotation phase different from that of the image immediately before taken.

6. The sheet monitor for a perfecter according to claim 5, wherein
the imaging means takes every image at a later point in the perfecter rotation phase than that of the image immediately before taken.

7. The sheet monitor for a perfecter according to claim 6, further comprising
a display, wherein
the display displays images, taken by the imaging means, in chronological order.

8. The sheet monitor for a perfecter according to claim 7, wherein
the display is provided in an operation stand operated by an operator.
